(19) United States
(12) Patent Application Publication
(10) Pub. No.: US 2023/0237405 A1
(43) Pub. Date: Jul. 27, 2023

(54) INFORMATION RECORDING MEDUIM DESTRUCTION DEVICE MANAGEMENT METHOD

(71) Applicants: Tomokazu KANDA, Sayama-shi, Saitama (JP); Masuo KARAKAMA, Chosei-gum, Chiba (JP)

(72) Inventors: Tomokazu KANDA, Sayama-shi (JP); Masuo KARAKAMA, Chosei-gun (JP)

(73) Assignees: Tomokazu KANDA, Sayama-shi, Saitama (JP); Masuo KARAKAMA, Chosei-gum, Chiba (JP)

(21) Appl. No.: 17/928,585

(22) PCT Filed: Jun. 15, 2021
(86) PCT No.: PCT/JP2021/022625

§ 371 Date: Nov. 29, 2022

(30) Foreign Application Priority Data
Jun. 16, 2020 (JP) 2020-104039

(51) Int. Cl. G06Q 10/0635

(52) U.S. Cl. CPC G06Q 10/0635

(57) ABSTRACT

A destruction device management method is provided that is capable of minimizing a risk that an information recording medium supposed to be disposed of as waste is taken out and distributed to a secondhand market and a risk that information leaks from the information recording medium.

In the present invention, a server device records personal identification information, destruction device identification information, and location information, received from a mobile terminal, in an information recording means. As a result, the server device can centrally manage information such as where the destruction device was located, which destruction device was used, and who performed the destruction work. That is, when the destruction of information recording medium is performed using the destruction device, the record is always stored in the server device. Therefore, the risk of information recording medium being taken outside by a malicious employee or the like can be suppressed because the information recording medium cannot be taken outside (under the false pretense that it has been destructed) without actually operating the destruction device at all.

### TECHNICAL FIELD

The present invention relates to a management method of a device configured to destruct an information recording medium (an electronic recording medium such as a hard disk drive or a semiconductor memory) that has been handled as waste. The present invention also relates to an automatic generation method of a destruction record (destruction proof) for proving a fact that an information recording medium has been destructed.

### BACKGROUND ART

Many kinds of confidential information such as personal information, trade secrets, and defense secrets are recorded in an information recording medium used by a company, an administrative agency, a local public organization, or the like (collectively referred to as “company or the like” in this application). Therefore, in a case where a company or the like disposes of an unnecessary information recording medium as waste, it is required to physically destruct the information recording medium.

As a physical destruction method of the information recording medium, bending destruction, drilling destruction, magnetic erasure by a strong magnetic field, and the like are adopted, and by physically destructing the information recording medium in this way, data recorded in the information recording medium cannot be read or restored.

In view of the demand for the above-described destruction processing of the information recording medium, in recent years, the demand for a dedicated destruction device configured to physically destruct the information recording medium has increased, and a large number of the destruction devices have been delivered to companies that have requested destruction processing to external contractors in addition to contractors that undertake disposal of the information recording medium.

A company or the like that has purchased the destruction device causes an employee belonging to the company to perform destruction work of an unnecessary information recording medium as a job.

In addition, a disposal contractor who has purchased the destruction device receives an order from a company or the like for destruction processing of the information recording medium, and causes an employee belonging to the disposal contractor to perform the destruction processing.

However, even in a case where a company or the like destructs an information recording medium internally, or even in a case where the company or the like requests an external disposal contractor, there is actually a considerable risk that the information recording medium is not destructed, but is taken out to the outside by an employee or the like (regular employees, temporary employees, contract employees, part-time workers, or the like) lacking morals, and is transferred to a secondhand market. In addition, such an incident has actually occurred.

In addition, there is a possibility that a contractor that undertakes destruction of the information recording medium entrusts actual destruction work to an external subcontractor, and in this case, there is a risk that the information recording medium is taken out without being actually destructed by the subcontractor or an employee thereof and transferred to a secondhand market.

In addition, there is a possibility that a contractor who has undertaken the destruction of the information recording medium lends the destruction device to another contractor and entrusts the actual destruction work to the contractor that is a destination of lending. Even in this case, there is a risk that the information recording medium is not actually destructed by the contractor that has received lending or its employee and is leaked to the secondhand market.

Then, in a case where an information recording medium that is supposed to be disposed of as waste is distributed in a secondhand market, a large amount of pieces of confidential information leaks to the outside, business reliability is impaired for a company or the like, and in some cases, a problem arises in that security in national defense is impaired, and the company or the like is fatally damaged.

Therefore, it is required to keep a destruction record (destruction proof) with high probative force that can truly prove the fact that the information recording medium was destructed.

On the other hand, with an increase in demand for an information recording medium destruction device, it has been studied by the inventors of the present application that the destruction device is lent and charged according to the frequency of use or the like. However, it is difficult to individually and accurately grasp a frequency of use of each of a large number of destruction devices lent to various contractors and the like.

### SUMMARY OF INVENTION

### Technical Problem

In view of the above-described problem, an object of the present invention is to provide a destruction device management method capable of suppressing at a maximum a risk that an information recording medium to be disposed of as waste is taken out and distributed to a secondhand market and a risk that information leaks from the information recording medium. Another object of the present invention is to provide a destruction device management method for making it possible to easily and accurately grasp the frequency of use of each of a large number of information recording medium destruction devices. Another object of the present invention is to provide a method for automatically generating a destruction record (destruction proof) having a high probative force that can truly prove the fact that the information recording medium has been destructed.

### Solution to Problem

The foregoing object is achieved by a destruction device management method including:

(a) a step of reading, by a mobile terminal, via its own camera means, destruction device identification information included in an identification display of a destruction device before starting a destruction work using the destruction device;

(b) a step of acquiring, by the mobile terminal, via its own location information acquisition means, location information on a current location of the mobile terminal at the time of execution of the step (a);

(c) a step of transmitting, by the mobile terminal to a server device,

personal identification information for identifying a person who uses the mobile terminal,

the destruction device identification information read in the step (a), and

the location information acquired in the step (b); and

(l) a step of recording, by the server device in an associated state

the personal identification information, the destruction device identification information, and the location information

received from the mobile terminal

in an information recording means.

The destruction device management method may further include:

(h) a step of capturing, by the mobile terminal, by using a camera means, an external appearance of an information recording medium as waste after being destructed, and acquiring post-destruction image data in which the external appearance is captured; and

(i) a step of transmitting, by the mobile terminal, the post-destruction image data acquired in the step (h) to the server device.

In this case, in the step (l),

the server device records in an associated state the personal identification information, the destruction device identification information, the location information, and the post-destruction image data received from the mobile terminal in the information recording means.

Furthermore, the destruction device management method may further include:

(f) a step of capturing, by the mobile terminal by using the camera means, an external appearance of an information recording medium as waste before being destructed, and acquiring pre-destruction image data in which the external appearance is captured; and

(g) a step of transmitting, by the mobile terminal, the pre-destruction image data acquired in the step (f) to the server device.

In this case, in the step (l),

the server device records in an associated state the personal identification information, the destruction device identification information, the location information, the pre-destruction image data, and the post-destruction image data received from the mobile terminal in the information recording means.

In the destruction device management method, the information recording medium to be destructed has an identification display indicating medium identification information for identifying the information recording medium.

In this case, in the step (f), the pre-destruction image data acquired by the mobile terminal by using the camera means includes an identification display indicating the medium identification information.

In this case, in the step (h), the post-destruction image data acquired by the mobile terminal by using the camera means includes an identification display indicating the medium identification information.

Furthermore, in the destruction device management method,

in the step (l), the information to be recorded in an associated state by the server device in the information recording means may further include information on a requester of destruction of the information recording medium.

Furthermore, the destruction device management method may further include:

(d) a step of reading, by the mobile terminal by using its own camera means, a pre-work counter value that is a numerical value displayed on a counter of the destruction device, before starting a destruction work using the destruction device; and

(e) a step of transmitting, by the mobile terminal, the pre-work counter value read in the step (d) to the server device.

In this case, in the step (l),

the server device records in an associated state the personal identification information, the destruction device identification information, the location information, and the pre-work counter value received from the mobile terminal in the information recording means.

Furthermore, the destruction device management method may further include:

(j) a step of reading, by the mobile terminal by using its own camera means, a post-work counter information that is a numerical value displayed on a counter of the destruction device, after completing a destruction work using the destruction device; and

(k) a step of transmitting, by the mobile terminal, the post-work counter value read in the step (j) to the server device.

In this case, in the step (l),

the server device records in an associated state the personal identification information, the destruction device identification information, the location information, the pre-work counter value and post-work counter value received from the mobile terminal in the information recording means.

Furthermore, the destruction device management method may further include:

a step of calculating, by the server device, the number of destruction times in the current destruction work based on the pre-work counter value and the post-work counter value.

In this case, in the step (l),

the server device records in an associated state the personal identification information, the destruction device identification information, the location information, and the pre-work counter value, the post-work counter value, and the number of destruction times in the current destruction work received from the mobile terminal in the information recording means.

In the destruction device management method, the server device may obtain an increase amount of the counter value in the predetermined period for each of the plurality of destruction devices based on the pre-work counter value and the post-work counter value.

In addition, the destruction device used in the destruction device management method includes, as means configured to physically destruct the information recording medium, for example,

a pressurization-type destruction means that applies pressure to destruct the information recording medium to be destructed, or

a magnetic type destruction means that applies magnetic force to destruct the information recording medium to be destructed.

The pressurization-type destruction means includes, for example,

a pressurizing unit including a plurality of hydraulic cylinders configured to apply pressure so as to destruct information recording medium to be destructed, and

a hydraulic pressure source configured to supply hydraulic oil to each hydraulic cylinder of the pressurizing unit.

In addition, the above-described object is achieved by automatically generating an information recording medium destruction record (destruction proof) on which any one or more of the following 1 to 6 is posted on the basis of information registered in an information recording medium of a server device.

1. Information regarding a requester of destruction of information recording medium (a name of company or organization, and the like)

2. Evidence images (images before and after destruction and the like) of information recording medium to be destructed.

3. Identification information of information recording medium to be destructed

4. Date and time when destruction of information recording medium was performed

5. Location where destruction of information recording medium was performed (address, latitude and longitude, map, and the like)

6. Information regarding a person in charge who performed destruction of information recording medium (name, affiliation, and the like)

### Advantageous Effects of Invention

In the present invention, the server device records in an associated state the personal identification information, the destruction device identification information, and the location information received from the mobile terminal in the information recording means.

As a result, the server device can centrally manage information such as where the destruction device was located, which destruction device was used, and who performed the destruction work. That is, when the destruction of information recording medium is performed using the destruction device, the record is always stored in the server device.

Therefore, the risk of information recording medium being taken outside by a malicious employee or the like can be suppressed because the information recording medium cannot be taken outside (under the false pretense that it has been destructed) without actually operating the destruction device at all.

In addition, since such information as where the destruction device was located, which destruction device was used, and who performed the destruction work can be retroactively confirmed at any time, it is possible to contribute to improve credibility with respect to destruction processing of the information recording medium.

In addition, since the above-described information is transmitted to the server device each time the destruction work using the destruction device is started, it is possible to grasp at least whether or not the destruction device is used at a remote place. Therefore, when the destruction device is lent, it is possible to charge for use of the destruction device.

In addition, by grasping the location information of the destruction device, in a case where the destruction device is lent, it is possible to prevent the destruction device from being subleased without permission.

Furthermore, by recording the location information of the destruction device, in a case where the destruction processing of the destruction device is requested to an external contractor, it is possible to confirm whether the destruction work is appropriately destructed by the request destination (without being left to another contractor). Therefore, in a case where the destruction of the information recording medium is requested to an external contractor, a company or the like can obtain a sense of security (that the destruction processing is appropriately performed in the contractor).

In the present invention, the server device records, in an associated state, the personal identification information, the destruction device identification information, the location information, the pre-destruction image data, and the post-destruction image data received from the mobile terminal in the information recording means.

The “pre-destruction image data” is visual evidence data indicating an external appearance of the information recording medium before the destruction, and the “post-destruction image data” is visual evidence data indicating that the information recording medium has been destructed.

By keeping a record in the server device including such visual evidence data (image data before and after destruction), it is possible to prevent a false report (a false report that the server device is destructed when it is not actually destructed). Therefore, the risk of information recording medium being taken outside by a malicious employee or the like can be further suppressed. In addition, for a company or the like that disposes of the information recording medium, it is possible to obtain a sense of security by keeping visual evidence of destruction.

In addition, by keeping a record in the server device including such visual evidence data (image data before and after destruction), it is possible to contribute to improvement of credibility of a disposal contractor using the destruction device.

In the present invention, the information recording medium to be destructed has an identification display indicating medium identification information for identifying the information recording medium. This identification display is configured by, for example, a seal such as a barcode or a serial number affixed by a manufacturer of the information recording medium, a seal such as a barcode or a serial number affixed by a user of the information recording medium (a person who discards the information recording medium), and identification information such as a number or a symbol handwritten by the user of the information recording medium with a magic pen or the like.

Therefore, the above-described visual data (image data before and after destruction) inevitably includes the above-described identification display.

As a result, the destruction process cannot be falsified, and thus the risk of information recording medium being taken outside by a malicious employee or the like can be further suppressed.

In addition, by including the identification display in the visual data (image data before and after destruction), it is possible to retroactively confirm the presence or absence of the destruction processing of the specific information recording medium.

In addition, for a company or the like that disposes of the information recording medium, it is possible to obtain a sense of security by keeping visual evidence of destruction including individual identification display.

In the present invention, the information recorded in the information recording means by the server device may include information on the requester of destruction. As a result, it is possible to search for and confirm evidence of destruction or the like for each requester regarding the information to be centrally managed by the server device.

According to the present invention, since the counter value of the destruction device can be grasped at a remote place, when the destruction device is lent, billing based on the counter value can be performed similarly to a lease copier or the like.

In addition, in the server device, falsification of the counter value can be prevented by centrally managing the counter value of each destruction device.

### BRIEF DESCRIPTION OF DRAWINGS

FIG. 1 is a diagram illustrating an outline of a destruction device management method according to the present invention.

FIG. 2 is a diagram illustrating an outline of the destruction device management method according to the present invention.

FIG. 3 each is a front view and a side view illustrating an example of the destruction device used for implementing the management method according to the present invention.

FIG. 4 each is a view illustrating an example of an internal structure of the destruction device.

FIG. 5 is a block diagram illustrating a functional configuration of a server device used for implementing the management method according to the present invention.

FIG. 6 is a diagram illustrating an example of information registered in a “user management file” of the server device.

FIG. 7 is a diagram illustrating an example of information registered in a “destruction device management file” of the server device.

FIG. 8 is a diagram illustrating an example of information registered in an “evidence management file” of the server device.

FIG. 9 is a view illustrating an example of a pre-destruction evidence image and a post-destruction evidence image captured in the destruction device management method.

FIG. 10 is a diagram illustrating an example of destruction proof (destruction record) proving the fact that the information recording medium is destructed.

FIG. 11 is a diagram illustrating another example of destruction proof (destruction record) proving the fact that the information recording medium has been destructed.

FIG. 12A is a flowchart illustrating a flow of processing in a destruction device management method.

FIG. 12B is a flowchart illustrating a flow of processing in the destruction device management method.

### DESCRIPTION OF EMBODIMENT

Hereinafter, a specific embodiment of an “information recording medium destruction device management method” according to the present invention will be described.

(Outline of Information Recording Medium Destruction Device Management Method)

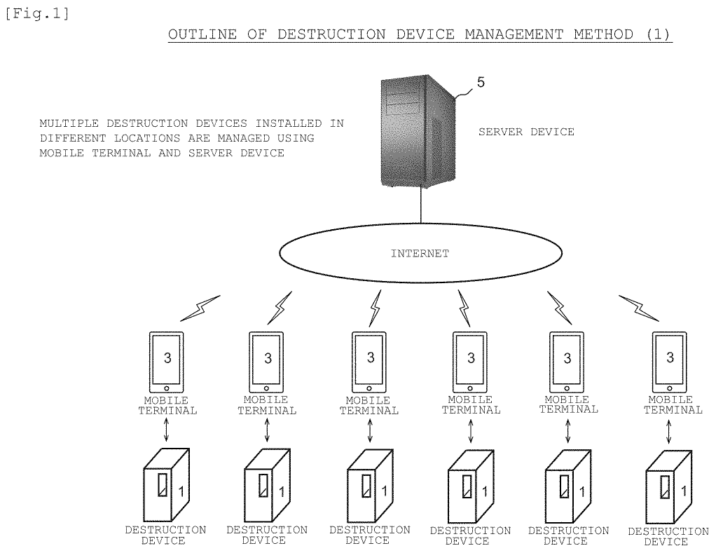

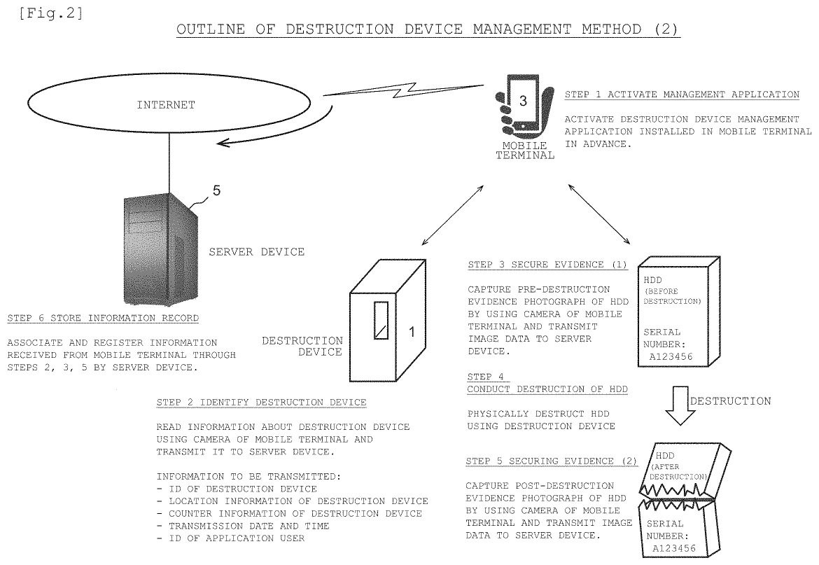

An outline of a destruction device management method is each illustrated in FIGS. 1 and 2.

The management method according to the present embodiment is a method for managing a plurality of destruction devices 1 configured to physically destruct an information recording medium as waste. Specifically, the method is a method in which a large number of destruction devices 1 used by companies, administrative organizations, various groups, and the like in the world are centrally managed using a system (destruction device management system) including a mobile terminal 3 and a server device 5.

Specific examples of the information recording medium to be destructed by the destruction device 1 include a portable electronic recording medium (portable recording medium) including a hard disk drive, a semiconductor memory, and the like. The electronic recording medium includes a solid state drive in addition to a hard disk drive.

Note that, in the accompanying drawings, a hard disk drive (HDD) is illustrated as an example of an information recording medium to be destructed.

The destruction device 1 is a device configured to physically destruct an information recording medium treated as waste by a company or the like. Specific examples of the physical destruction of the information recording medium include bending destruction, drilling destruction, and magnetic erasure by a strong magnetic field. By physically destructing the information recording medium in this manner, data recorded in the information recording medium cannot be read. Alternatively, data cannot be restored.

In implementation of the management method according to the present embodiment, as illustrated in FIG. 1, a system including a plurality of mobile terminals 3 and a server device 5 that receives information transmitted from the mobile terminals via the Internet is used. In the mobile terminal 3, an application (management application) for managing a destruction device is installed. The management application is dedicated software used to implement the management method according to the present embodiment. An implementation procedure of the management method according to the present invention using this system is schematically shown in FIG. 2.

(Destruction Device)

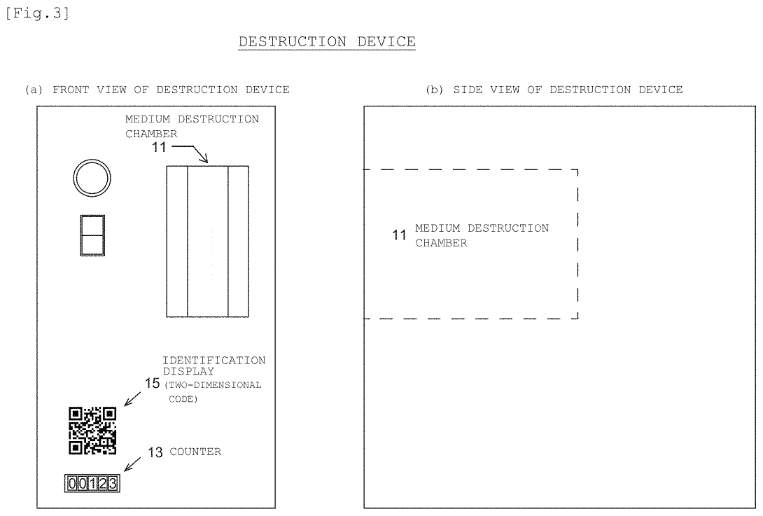

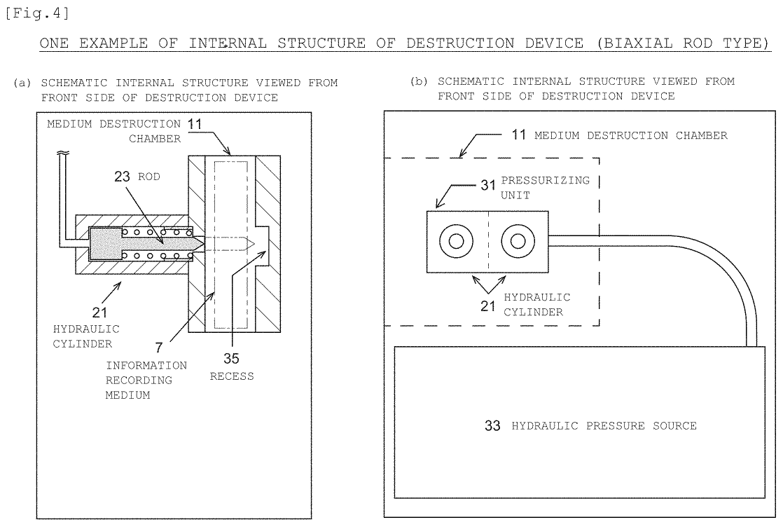

Next, a configuration of a destruction device used to implement the management method will be described with reference to FIGS. 3 and 4.

It is assumed that the destruction device to be managed by the management method according to the present embodiment is provided to companies, administrative agencies, various groups, and the like all over the world.

As shown in FIG. 3, each destruction device includes:
a medium destruction chamber 11 in which an information recording medium to be destructed is set;
a counter 13 that displays the total number of destruction times so far; and
an identification display 15 including destruction device identification information that is unique information for identifying a destruction device.

The medium destruction chamber 11 has a space in which an information recording medium to be destructed can be taken in and out.

In the counter 13, each time one information recording medium is destructed using the destruction device, the counter value increases by one.

In the present embodiment, a seal on which a two-dimensional code is printed is used as the identification display 15, but the identification display 15 is not limited thereto as long as it can be read using a camera, and for example, a seal on which a barcode is printed, a seal on which a serial number is printed, or the like can be used.

Furthermore, as illustrated in FIG. 4, the destruction device includes

as a means configured to apply a destruction action to the information recording medium 7 set in the medium destruction chamber 11,
a pressurizing unit 31 including a biaxial hydraulic cylinder 21,
a hydraulic pressure source 33 that functions as a power source of the pressurizing unit 31, and the like.

When the hydraulic oil is supplied from the hydraulic pressure source 33 toward the pressurizing unit 31, a rod 23 of each hydraulic cylinder advances toward the recess 35 formed in the destruction chamber 11. Then, the information recording medium set in the destruction chamber 11 is sandwiched between the leading end of the rod 23 of the hydraulic cylinder and the recess 35, receives strong pressure from the leading end of the rod 23 of the hydraulic cylinder in this state, and is bent in a substantially V shape (substantially dogleg shape) to be physically destructed.

The hydraulic cylinder included in the destruction device is not limited to the biaxial hydraulic cylinder illustrated in FIG. 4, and may be a uniaxial hydraulic cylinder or a triaxial or tetra-axial or more hydraulic cylinder.

In addition, the method for physically destructing the information recording medium is not limited to the method for bending the information recording medium into a substantially V shape, and may be a method for forming a large number of holes in the information recording medium by a triaxial or tetra-axial or more crushing section.

Furthermore, the method for physically destructing the information recording medium is not limited to the bending or drilling as described above, and for example, a method for applying a strong magnetic field to the information recording medium and magnetically erasing the information recording medium can be adopted.

The counter 13 displays the number of times the pressurizing unit 31 has been operated so far, that is, the total number of destruction times. Therefore, the number of destruction times of the information recording medium can be grasped by reading the counter value of the destruction device. In a case where the destruction device is lent for a fee, it is possible to charge money on the basis of the counter value.

The two-dimensional code of the identification display 15 includes unique identification information (ID) for identifying the destruction device. Therefore, by reading the identification information included in the identification display, it is possible to identify the solid of the destruction device.

Note that, in the present embodiment, the destruction device includes, as means configured to physically destruct the information recording medium, a pressurization-type destruction means that applies pressure to the information recording medium to destruct the information recording medium, but may include a magnetic destruction means configured to apply magnetic force to the information recording medium to destruct the information recording medium.

(Mobile Terminal)

Next, a configuration of a mobile terminal used to implement the management method will be described.

The mobile terminal is a portable information terminal having a wireless communication function or a camera capable of accessing the Internet, and specific examples thereof include a smartphone, a tablet terminal, and a mobile phone. In the present embodiment, a smartphone is used as a mobile terminal.

The mobile terminal mainly includes:
a wireless communication unit capable of accessing the Internet;
a location information reception section configured to acquire location information from a GPS satellite or the like;
a camera used to read a two-dimensional code or a counter value of a destruction device;
an internal storage for storing various types of information;
a display section (a display including a touch screen) for displaying various types of information;
a processor for controlling each of the above sections and executing steps to be described later, and the like.

The internal storage of the mobile terminal stores
personal identification information for identifying a person who uses the mobile terminal, and
a software such as a management application.

Personal identification information for identifying a person who uses the management application is registered in the management application. Specific examples of the personal identification information to be registered in the management application include a name and an employee number of the person.

In addition, the management application is authorized to access each of the wireless communication unit, the camera, and the location information receiving section. Therefore, it is possible to receive location information on the management application, to read necessary information via the camera, and to transmit information to the server device via the Internet.

(Server Device)

The server device 5 receives the information transmitted from the mobile terminal 1 via the Internet.

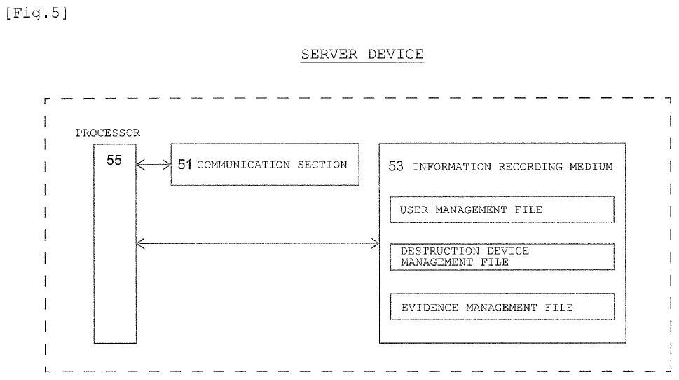

As illustrated in FIG. 5, the server device 5 includes:
a communication unit 51 for accessing the Internet;
an information recording medium 53 that stores various types of information received from the mobile terminal 1; and
a processor 55 for controlling each of the above sections.

As illustrated in FIG. 5, in the information recording medium 53 of the server device 5,
a user management file,
a destruction device management file, and
the evidence management file
   are registered.

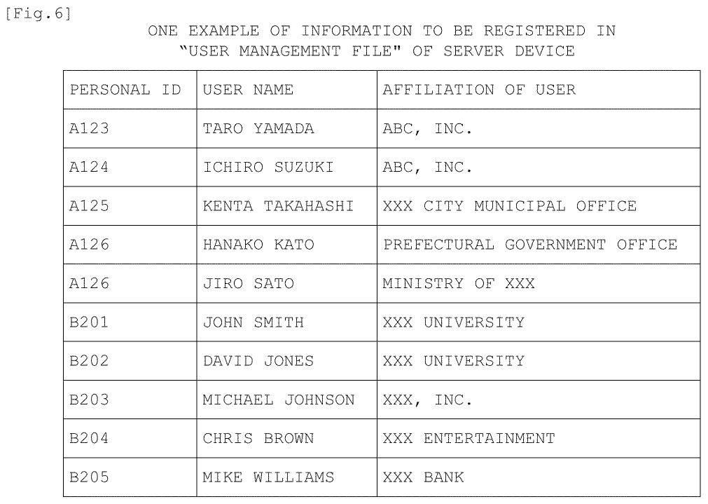

As illustrated in FIG. 6, in the user management file of the server device 5, a personal ID (for example, an employee number), a name, information regarding an affiliated company, and the like of a person who uses the management application are registered in association with each other on a per-individual basis.

Therefore, for example, when the personal ID or the user name is known, the associated company or the like associated with the personal ID or the user name can be instantly retrieved from the user management file, and when the associated company or the like is known, one or a plurality of personal IDs or user names associated with the associated company or the like can be instantly retrieved from the user management file.

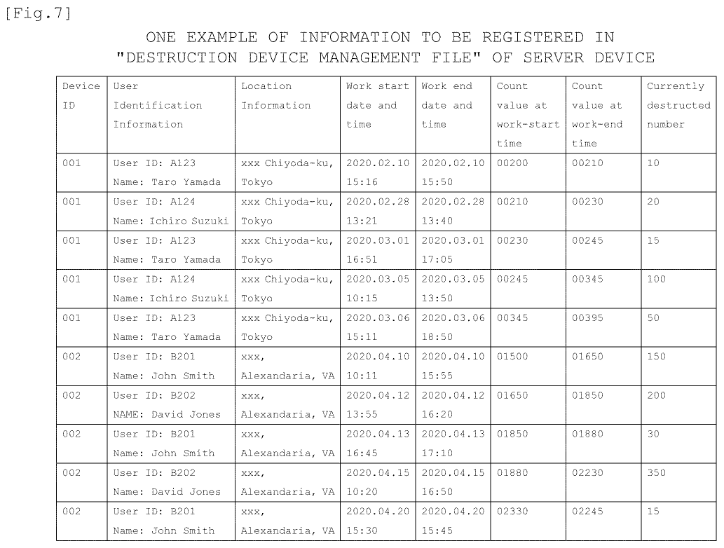

As illustrated in FIG. 7, a use history of each destruction device is recorded in the destruction device management file of the server device 5. The use history here is information regarding when, by whom, where installed, and which destruction device was used, and how many times the destruction device was used.

Every time the destruction device is used together with the mobile terminal in which the management application is installed, the next information is registered in the destruction device management file in association with (as one record) the information transmitted from the mobile terminal, and the destruction device management file is updated. That is, every time the destruction device is used, history information corresponding to one record is added to the destruction device management file in the server device, and the destruction device management file is updated.
Identification information of the destruction device,
identification information of a person who has used the destruction device (identification information of a person registered in the management application),
location information of place where destruction device is placed,
start date and time of destruction work (start date and time of use of destruction device),
end date and time of destruction work (use end date and time of destruction device),
counter value before start of destruction work (counter value at start of use of destruction device),
counter value after completion of destruction work (counter value when use of destruction device is finished), and
the number destructed by the current destruction work.

Each time one or a plurality of information recording media is destructed using the destruction device, the information of one record is added to the destruction device management file in an associated state.

Therefore, for example, when the identification information of the destruction device is known, the use history associated with the identification information (information such as who used the destruction device and when and where the destruction device was used) can be instantly retrieved from the destruction device management file. In addition, for example, when the identification information of the user is known, the use history associated with the identification information (information such as where the person used which destruction device) can be instantly retrieved from the destruction device management file.

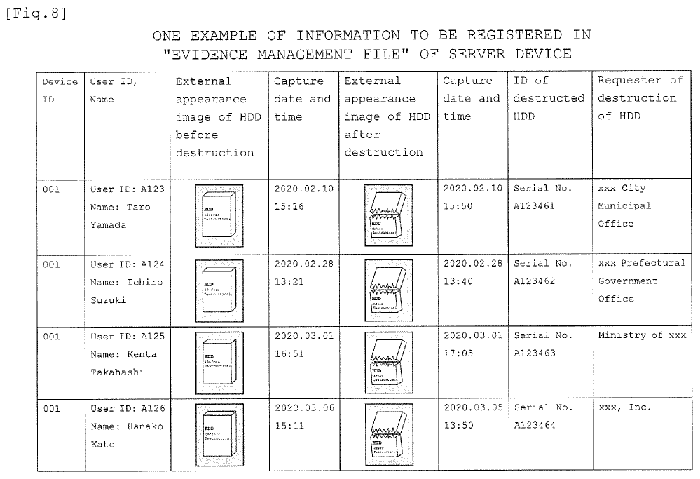

As illustrated in FIG. 8, information on evidence of destruction of the information recording medium is recorded in the evidence management file of the server device 5. The information on evidence of destruction here is information regarding when, by whom, and which destruction device was used to destruct which medium in what kind of manner.

Every time the information recording medium is destructed using the destruction device, the next information is registered in the evidence management file in association with (as one record) the information transmitted from the mobile terminal, and the evidence management file is updated. That is, every time the information recording medium is destroyed, evidence information corresponding to one record is added to the evidence management file in the server device, and the evidence management file is updated.
Identification information of the destruction device,
identification information of a person who has used the destruction device (identification information of a person registered in the management application),
image data (pre-destruction image data) showing the external appearance of the information recording medium before destruction,
captured date and time of the pre-destruction image data,
image data (post-destruction image data) showing the external appearance of the information recording medium after destruction,
captured date and time of the post-destruction image data,
identification information of destructed information recording medium, and
information regarding the requester of the destruction processing of the information recording medium (for example, the name or telephone number of a company or the like).

Each time the information recording medium is destructed using the destruction device, the information of one record is added to the evidence management file in an associated state.

Therefore, for example, when the identification information of the destruction device is known, the use history associated with the evidence of destruction (information such as who destructed which medium by using this destruction device) can be instantly retrieved from the destruction device management file. In addition, for example, when a requester of destruction (for example, a company name or the like) is known, evidence of destruction (information such as who destructed the information recording medium requested to be destructed by the requester using which destruction device.) associated with the requester can be instantly retrieved from the destruction device management file.

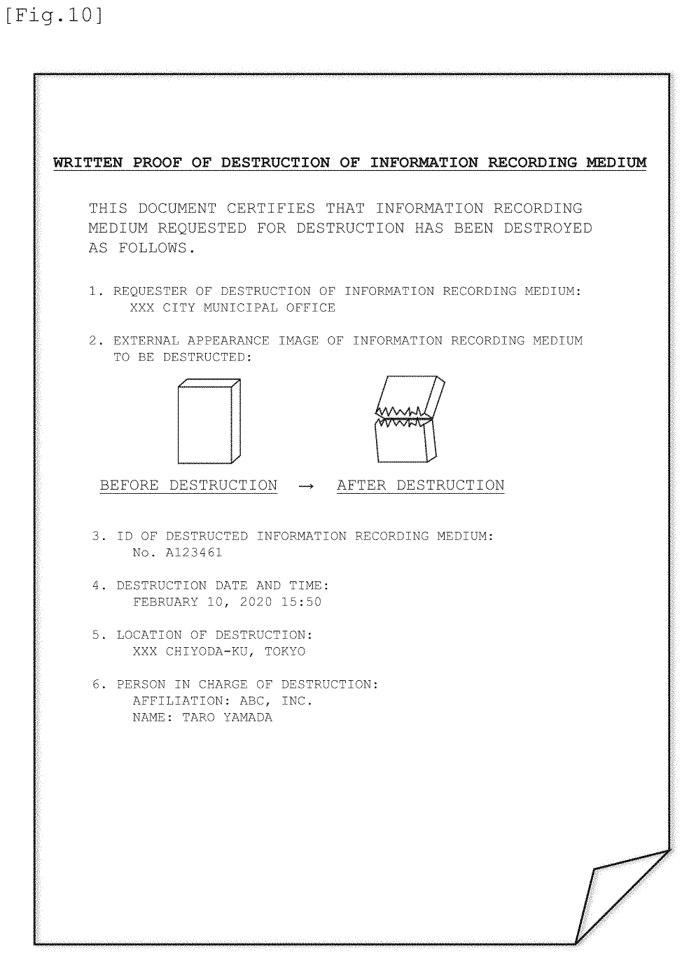

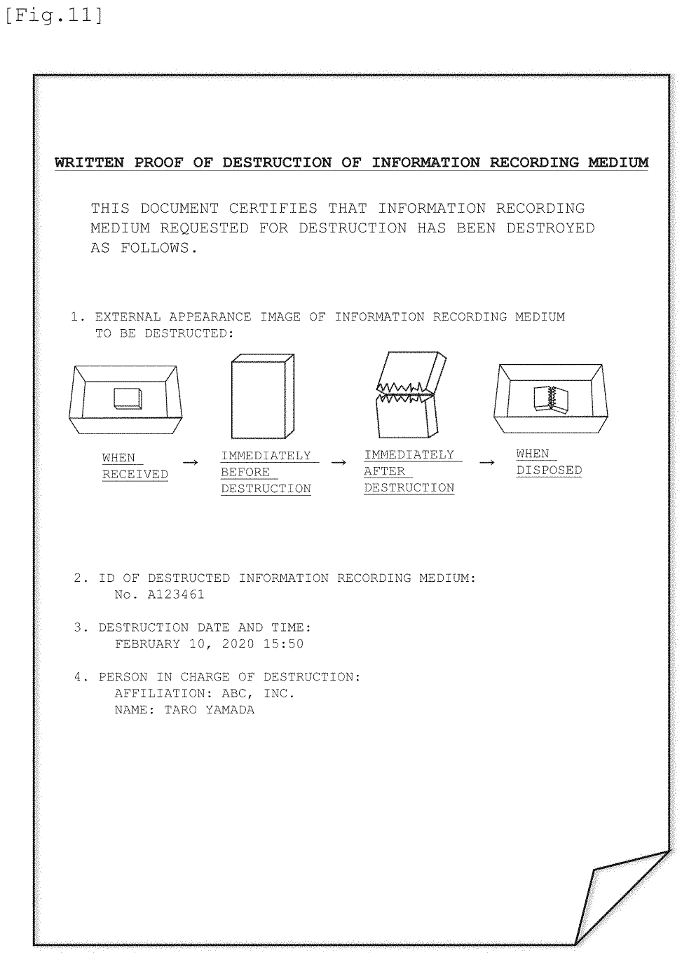

Then, by using various types of information included in the above-described destruction device management file and evidence management file, it is possible to automatically create a destruction record (destruction proof) of the information recording medium as illustrated in FIGS. 10 and 11. This destruction record (destruction proof) plays a role of truly proving the fact that the information recording medium was destructed, and can be used as a report to a destruction requester (destruction report of the information recording medium).

Hereinafter, a destruction record (destruction proof) of the information recording medium will be described.

In the present invention, the destruction record (destruction proof) of the information recording medium as illustrated in FIGS. 10 and 11 is automatically output using the destruction device management file and the evidence management file registered in the information recording medium of the server device.

Specifically, a destruction record (destruction proof) is automatically output on the basis of information corresponding to one record of the evidence management file and information of the destruction device management file associated with the information. By automatically outputting the destruction record (destruction proof) in this manner, it is possible to save time and effort to create a destruction report to the destruction requester.

The destruction record of the information recording medium may be generated in a browsable electronic file format such as PDF or HTML and stored in the server device. Alternatively, as illustrated in FIGS. 10 and 11, it may be printed (output as a paper medium) in a predetermined layout.

In the case of outputting in a browsable electronic file format such as PDF or HTML, the output electronic file of the destruction record (destruction proof) is registered in the destruction record file of the server device to be browsed at any time. In addition, in a case where the data is output in a browsable data format such as PDF or HTML, the data may be stored in a server device in a browsable state via the Internet, or may be automatically transmitted to a requesting company or the like by e-mail or the like.

In the destruction record (destruction proof) automatically output by the server device, for example, information as listed below is posted in a predetermined layout.

1. Information regarding a requester of destruction of information recording medium (a name of company or organization, and the like)

2. Evidence images (images before and after destruction and the like) of information recording medium to be destructed.

3. Identification information of information recording medium to be destructed

4. Date and time when destruction of information recording medium was performed

5. Location where destruction of information recording medium was performed (address, latitude and longitude, map, and the like)

6. Information regarding a person in charge who performed destruction of information recording medium (name, affiliation, and the like)

As the information 1 to 6 described above posted in the destruction record (destruction proof), various types of information included in the destruction device management file or the evidence management file registered in the server device can be used. This is specifically as follows.

Since each record of the evidence management file includes information regarding the requester (for example, the name of the requester) (see FIG. 8), this can be used as “Information regarding a requester of destruction of information recording medium”. Note that the “Information regarding a requester of destruction of information recording medium” to be posted in the destruction record (destruction proof) is not necessarily a name, and may be, for example, an identification code of the requester.

Since each record of the evidence management file includes external appearance image data before and after destruction of the information recording medium (see FIG. 8), this can be used as “evidence images of information recording medium to be destructed”. Note that, as illustrated in FIG. 10, the “evidence images of information recording medium to be destructed” may be only the evidence images before and after destruction. However, as illustrated in FIG. 11, an evidence image in which a series of processes (each stage from reception of request for destruction processing to completion of destruction) of “reception of destruction request→immediately before destruction→immediately after destruction→disposal processing” can be visually recognized may be posted. By posting evidence images visually proving a series of processes in this manner, it is possible to enhance the probative force of destruction records (destruction proofs).

Since each record of the evidence management file includes the ID of the destructed information recording medium (see FIG. 8), this can be used as “identification information of information recording medium to be destructed”.

Since each record of the evidence management file includes the information regarding the photographing date and time of the post-destruction image of the information recording medium (see FIG. 7), this can be used as the “date and time when the destruction of the information recording medium is performed”. In addition, since each record of the destruction device management file includes information regarding the work start date and time and the work end date and time, this can also be used as “location where destruction of information recording medium was performed”.

Since each record of the destruction device management file includes the location information (information related to the location of the destruction device), this can be used as “location where destruction of information recording medium was performed”. The “location where destruction of information recording medium was performed” posted in the destruction record (destruction proof) may be any of an address indicating a location of the destruction device, latitude and longitude, and a map.

Note that, since each record of the evidence management file and each record of the destruction device management file are in an association with each other by the device ID and the identification information of the user, a specific record of the destruction device management file can be accessed from a specific record of the evidence management file.

Since each record of the evidence management file includes information (Name, ID) regarding the user of the destruction device (see FIG. 8), this can be used as “information regarding a person in charge who performed destruction of information recording medium”. Note that the “information regarding a person in charge who performed destruction of the information recording medium” described in the destruction record may include a face photograph of the person, a name of an organization to which the person belongs, and the like.

Note that the above described pieces of information 1 to 6 are not necessarily all posted on the destruction record (destruction proof), and one or two or more pieces of information arbitrarily selected from these pieces of information may be posted on the destruction record (destruction proof) as necessary.

(Information Recording Medium Destruction Device Management Method)

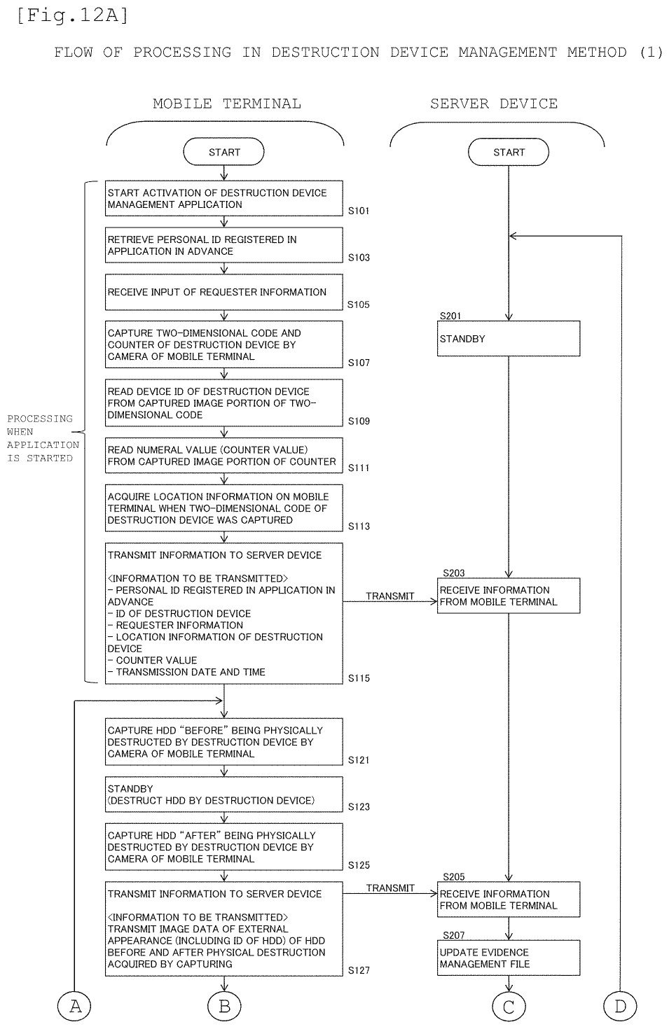

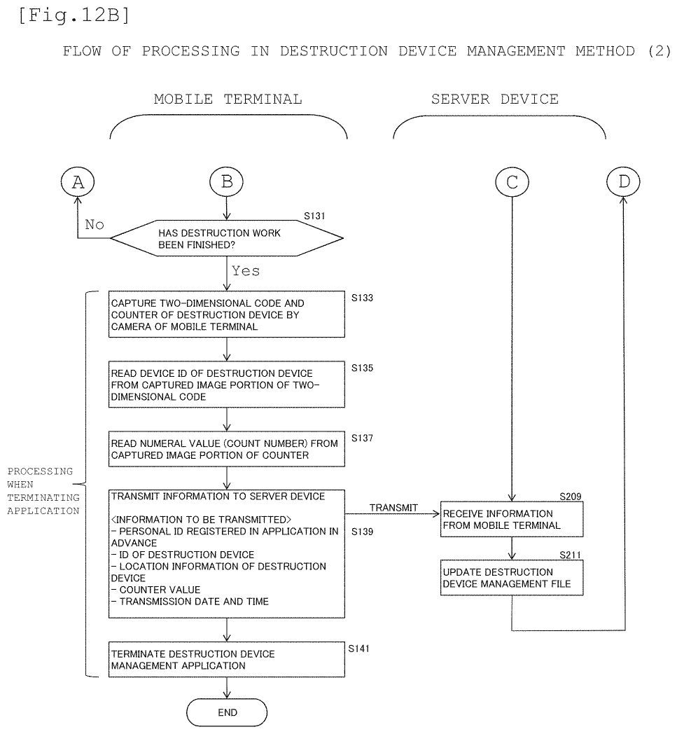

Next, a destruction device management method using a mobile terminal and a server device will be mainly described with reference to each flowchart of FIG. 12.

In implementing the management method of the present embodiment, first, a worker (a person in charge of the destruction processing) who performs the destruction processing of the information recording medium moves, with a mobile terminal, to a work site where the destruction device is placed.

Next, when the worker arrives at the site where the destruction device is placed, the worker performs an operation of starting the management application installed in the mobile terminal. In response to this operation, the mobile terminal starts activation of the management application <step S101 in FIG. 12>.

Next, when the management application is activated, the mobile terminal retrieves personal identification information registered in the management application in advance <S103>. The personal identification information mentioned herein is information for identifying a person who uses the management application. Specific examples of the personal identification information to be registered in the management application include a name and an employee number of the person who uses the management application. In addition, the personal identification information may include image data of a face photograph of a person who uses the management application.

Next, the worker inputs requester information to the mobile terminal. The requester information is a name, a telephone number, an e-mail address, or the like of a company or the like that has requested destruction of the information recording medium (information recording medium to be destructed). The requester information input operation may be input using a software keyboard of a mobile terminal or may be selected from a drop-down list. By this input operation, the mobile terminal receives the input of the requester information <S105>.

Next, the worker activates the camera of the mobile terminal being brought with the worker, and orients the camera lens of the mobile terminal to face the two-dimensional code of the destruction device and the counter (see FIG. 3(a)) to capture these images <S107>.

Then, the mobile terminal reads the destruction device identification information from the image portion of the two-dimensional code captured by the camera <S109>. At the same time, the mobile terminal reads the pre-work counter value (the counter value before starting the destruction work) from the image portion of the counter captured by the camera <S111>.

Furthermore, at the time of reading the destruction device identification information, the mobile terminal acquires location information (information on the current location of the mobile terminal) from a GPS satellite or the like via its own location information acquisition means <S113>. The location information acquired through the mobile terminal is treated as information on the current location of the destruction device.

Then, the mobile terminal transmits
the personal identification information retrieved in step S103;
the requester information whose input has been accepted in step S105;
the destruction device identification information read in step S109;
the pre-work counter value read in step S111; and
the location information acquired in step S113

to the server device together with time information at the time of transmission <S115>.

Next, before destructing the information recording medium to be destructed, the worker orients the camera of the mobile terminal to face the information recording medium to capture the external appearance thereof. As a result, the mobile terminal acquires the pre-destruction image data in which the external appearance of the information recording medium before the destruction is captured <S121>.

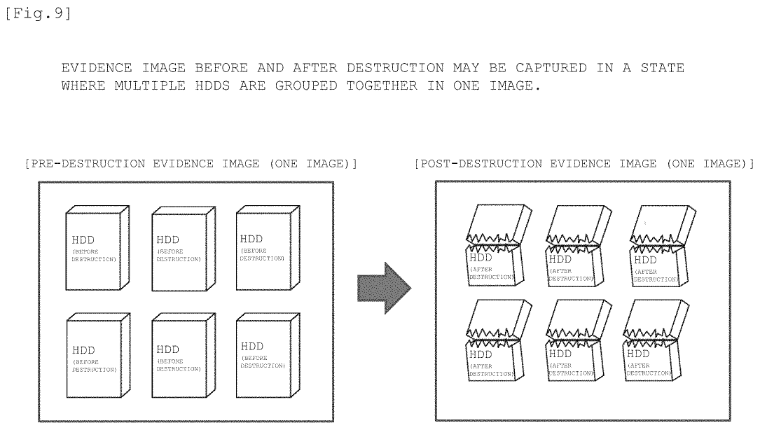

As the pre-destruction image data, image data in which an information recording medium to be destructed is captured alone can be used. Alternatively, in a case where destruction of a plurality of information recording media is requested from a company or the like, as illustrated on the left side of FIG. 9, image data captured in a state where the plurality of information recording media are collected can be used as the pre-destruction image data.

The information recording medium to be destructed has an identification display including medium identification information for identifying the information recording medium. Therefore, the pre-destruction image data acquired by the mobile terminal via the camera includes the identification display indicating the medium identification information.

The medium identification information mentioned herein is unique information for identifying the information recording medium. The identification display including the medium identification information may be provided by a manufacturer of the information recording medium, or may be provided by a company or the like that discards the information recording medium. Specific examples of the identification display include a serial number, a barcode, a two-dimensional code, a handwritten numeral or character, and a handwritten sign.

Next, the worker loads the information recording medium into the medium destruction chamber of the destruction device, and subsequently operates a pressurizing unit including a biaxial hydraulic cylinder or the like to physically destruct the information recording medium. Meanwhile, the mobile terminal stands by with the management application being activated <S123>.

Next, the worker takes out the destructed information recording medium from the destruction device, again orients the camera of the mobile terminal to face the information recording medium to capture the external appearance thereof. As a result, the mobile terminal acquires the post-destruction image data in which the external appearance of the information recording medium after the destruction is captured <S125>. The post-destruction image data acquired by the mobile terminal by using the camera means includes an identification display including the medium identification information.

As the post-destruction image data, image data in which an information recording medium to be destructed is captured alone can be used. Alternatively, in a case where destruction of a plurality of information recording media is requested from a company or the like, as illustrated on the right side of FIG. 9, image data captured in a state where the plurality of information recording media are collected can be used as the post-destruction image data.

Then, the mobile terminal transmits
the pre-destruction image data acquired in step S121; and
the post-destruction image data acquired in step S125 to the server device <S127>.

The server device adds information corresponding to one record to the evidence management file on the basis of the information received from the mobile terminal through steps S203 and S205, and updates the evidence management file <S207>. See FIG. 8 for the evidence management file.

The information for one record added to the evidence management file by the server device includes the following information as illustrated in FIG. 8.
Identification information of the destruction device
Identification information of a person who has used the destruction device (identification information of a person registered in the management application)
Image data (pre-destruction image data) showing external appearance of information recording medium before destruction
Captured date and time of pre-destruction image data
Image data (post-destruction image data) showing external appearance of information recording medium after destruction
Captured date and time of post-destruction image data
Identification information of destructed information recording medium
Information regarding a requester of destruction processing of information recording medium (for example, the name or telephone number of a company or the like)

Note that the information for one record added to the evidence management file may include, in addition to the image data before and after destruction of the information recording medium, image data that shows a state when the information recording medium is received, image data that shows a state of being loaded into the destruction device, and the like.

Next, the worker activates the camera of the mobile terminal brought with the worker (similarly to step S107), and orients the camera lens of the mobile terminal to face the two-dimensional code of the destruction device and the counter (see FIG. 3(a)) to capture these images <S133>.

Then, the mobile terminal reads the destruction device identification information from the image portion of the two-dimensional code captured by the camera <S135>. At the same time, the mobile terminal reads the post-work counter value (the counter value after completion of the destruction work) from the image portion of the counter captured by the camera <S137>.

Then, the mobile terminal transmits
the personal identification information retrieved in step S103,
the destruction device identification information read in step S135, and
the post-work counter value read in step S137,

to the server device together with time information at the time of transmission <S139>.

On the other hand, the server device adds information corresponding to one record to the destruction device management file on the basis of the information received from the mobile terminal through steps S203 and S209, and updates the destruction device management file <S211>. See FIG. 7 for the destruction device management file.

The information for one record added to the destruction device management file by the server device includes the following information as illustrated in FIG. 7.
Identification information of the destruction device
Identification information of a person who has used the destruction device (identification information of a person registered in the management application)
Location information of place where destruction device is placed
Start date and time of destruction work (start date and time of use of destruction device)
End date and time of destruction work (use end date and time of destruction device)
Pre-work counter value (counter value at start of use of destruction device)
Post-work counter value (counter value when use of destruction device is finished)
The number destructed by the current destruction work

Note that “the number destructed by the current destruction work” is a value calculated by the server device on the basis of the pre-work counter value and the post-work counter value.

Based on the pre-work counter value and the post-work counter value recorded in the destruction device management file, the increase amount of the counter value in the predetermined period can be obtained for each of the plurality of destruction devices.

In a case where the destruction device is lent for a fee, an invoice may be automatically created on the basis of the “increase amount of the counter value in the predetermined period” calculated by the server device, and the invoice may be transmitted to the contractor to which the destruction device is lent by e-mail or the like.

### REFERENCE SIGNS LIST

1 destruction device
3 mobile terminal
5 server device
7 Information recording medium
11 medium destruction chamber
13 counter
15 identification display
21 hydraulic cylinder
23 rod
31 pressurizing unit
33 hydraulic pressure source
35 recess
51 communication unit
53 Information recording medium
55 processor

1. A destruction device management method for managing a plurality of destruction devices configured to physically destruct an information recording medium as waste using a system including a mobile terminal and a server device, the destruction device management method being an information recording medium destruction device management method, wherein
the plurality of the destruction devices each include:
a destruction means configured to apply a destruction action to physically destruct an information recording medium;
a counter for displaying the total number of destruction times so far; and
an identification display including destruction device identification information that is unique information for identifying each destruction device,
the mobile terminal includes:
an information recording means configured to store personal identification information for identifying a person who uses the mobile terminal;
a location information acquisition means configured to acquire location information of the mobile terminal; and
a camera means configured to capture an external appearance of an information recording medium to be destructed,
the server device includes:
an information recording means configured to store information received from the mobile terminal,
the information recording medium destruction device management method further comprising:
(a) a step of reading, by the mobile terminal, via its own camera means, the destruction device identification information included in the identification display of the destruction device before starting a destruction work using the destruction device;
(b) a step of acquiring, by the mobile terminal, via its own location information acquisition means, location information on a current location of the mobile terminal at the time of execution of the step (a);
(c) a step of transmitting, by the mobile terminal, to the server device,
personal identification information for identifying a person who uses the mobile terminal,
the destruction device identification information read in the step (a), and
the location information acquired in the step (b); and
(l) a step of recording, by the server device, in an information recording means, the personal identification information, the destruction device identification information, and the location information received from the mobile terminal.

2. The information recording medium destruction device management method according to claim 1, further comprising:
(h) a step of capturing, by the mobile terminal by using the camera means, an external appearance of an information recording medium as waste after the information recording medium has been destructed, and acquiring post-destruction image data in which the external appearance has been captured; and
(i) a step of transmitting, by the mobile terminal, the post-destruction image data acquired in the step (h) to the server device, wherein
in the step (l)
the server device records, in the information recording means, the personal identification information, the destruction device identification information, the location information, and the post-destruction image data received from the mobile terminal.

3. The information recording medium destruction device management method according to claim 2, further comprising:
(f) a step of capturing, by the mobile terminal by using the camera means, an external appearance of an information recording medium as waste before being destructed and acquiring pre-destruction image data in which the external appearance has been captured; and
(g) a step of transmitting, by the mobile terminal, the pre-destruction image data acquired in the step (f) to the server device, wherein
in the step (l)
the server device records, in the information recording means, the personal identification information, the destruction device identification information, the location information, the pre-destruction image data, and the post-destruction image data received from the mobile terminal.

4. The information recording medium destruction device management method according to claim 3, wherein
an information recording medium to be destructed has an identification display indicating medium identification information for identifying the information recording medium, and
in the step (f),
the pre-destruction image data acquired by the mobile terminal by using the camera means includes an identification display indicating the medium identification information, and
in the step (h),
the post-destruction image data acquired by the mobile terminal by using the camera means includes an identification display indicating the medium identification information.

5. The information recording medium destruction device management method according to claim 1, wherein
in the step (l),
the information to be recorded in the information recording means by the server device further includes information on a requester of destruction of the information recording medium.

6. The information recording medium destruction device management method according to claim 1, further comprising:
(d) a step of reading, by the mobile terminal by using its own camera means, a pre-work counter value that is a numerical value displayed on a counter of the destruction device, before starting a destruction work using the destruction device; and
(e) a step of transmitting, by the mobile terminal, the pre-work counter value read in the step (d) to the server device, wherein
in the step (l),
the server device records, in the information recording means, the personal identification information, the destruction device identification information, the location information, and the pre-work counter value received from the mobile terminal.

7. The information recording medium destruction device management method according to claim 6, further comprising:
(j) a step of reading, by the mobile terminal, by using its own camera means, a post-work counter information that is a numerical value displayed on a counter of the destruction device, after completing a destruction work using the destruction device;
(k) a step of transmitting, by the mobile terminal, the post-work counter value read in the step (j) to the server device, wherein
in the step (l),
the server device records, in the information recording means, the personal identification information, the destruction device identification information, the location information, the pre-work counter value, and the post-work counter value received from the mobile terminal.

8. The information recording medium destruction device management method according to claim 7, further comprising
a step of calculating, by the server device, the number of destruction times in the current destruction work based on the pre-work counter value and the post-work counter value, wherein
in the step (l),
the server device records, in the information recording means, the personal identification information, the destruction device identification information, the location information, the pre-work counter value, the post-work counter value, and the number of destruction times in the current destruction work received from the mobile terminal.

9. The information recording medium destruction device management method according to claim 7, wherein
an increase amount of the counter value in a predetermined period is obtained for each of the plurality of destruction devices based on the pre-work counter value and the post-work counter value recorded in the information recording means of the server device.
